(19) United States
(12) Patent Application Publication
(10) Pub. No.: US 2009/0064554 A1
(43) Pub. Date: Mar. 12, 2009

(54) TAG HOLDER FIXED IN A RAIL

(75) Inventors: Manuel Alves, Tortosendo (PT); Pedro Cunha, Varberg (SE)

Correspondence Address: EGBERT LAW OFFICES, 412 MAIN STREET, 7TH FLOOR, HOUSTON, TX, 77002, US

(73) Assignee: JOALPE INDUSTRIA DE EXPOSITORES, S.A., P-6200 Tortosendo (PT)

(21) Appl. No.: 11/815,275

(22) PCT Filed: Jan. 12, 2006
(86) PCT No.: PCT/EP2006/000282

§ 371 Date: Jul. 1, 2008

(30) Foreign Application Priority Data
Feb. 16, 2005 (FR) 05/01539

(51) Int. Cl. G09F 3/18; G09F 3/00

(52) U.S. Cl. 40/652; 40/642.01

(57) ABSTRACT

The invention concerns a tag holder including a support for displaying information, such as a price tag, as well as fixing mechanism adapted to cooperate with a slide or rail provided at the front of a display surface, such as the surface of a shelf of a rack. The fixing mechanism includes a staple with a terminal engagement device cooperating with a lateral end of the slide, and a hinge adapted to enable a first position of the staple inserted into the slide and a second position of the staple internally locked.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a tag holder for the display of information, such as in particular, a price tag, designed for being fixed in a slide or a rail with a C or E-shaped profile.

The invention will find a particular application in all the fields of economic activity where it is desirable to display information, such as tags, in the form of cardboard, or still electronic tags.

2. Description of Related Art Including Information Disclosed Under 37 CFR 1.97 and 37 CFR 1.98.

In the field of commercial displays, and in particular in selling premises, it is known to fix tag holders to rails.

In the case of shelves with so-called thin trays, for instance, realized by means of a sheet metal, it is known to incorporate a C-shaped rail on the front edge of the tray.

The rail may still be added on, or fixed by means of an adhesive, on a front section of the display surface. In such a case, the tag holder is generally made of plastic material, in particular by extrusion processes.

Today, it is known to attach the tag holders by means of a jumper capable of cooperating elastically, inside the rail. The jumper is generally of a width greater than the rated width of the rail for being fixed by simple pressure.

However, by reason of the production uncertainties and manufacturing tolerances, it may happen that the fastening of the jumper to the rail is loose. The intrinsic resilience of the plastic forming the jumper, or still the rail, may not be sufficient to compensate for manufacturer differences.

In such a case, the fastening of the tag holder to the rail is not satisfactory because the tag holder slips too easily along the rail or comes loose from the rail.

### BRIEF SUMMARY OF THE INVENTION

This invention intends to remedy the shortcomings aforementioned, while offering a tag holder providing for an efficient attachment while suiting the width of the rail, as well as a simple and/or economical manufacturing process.

Another aim of the invention is to provide a tag holder which cannot slip easily inside the rail, once mounted therein.

Another aim of the invention is to provide a tag holder whereof the fastening to the rail is easy and quick.

Other aims and advantages of the invention will appear in the following description, which is given only by way of example, and without being limited thereto.

The present invention relates to a tag holder exhibiting supporting means for the display of information, such as in particular a price tag, as well as fastening means capable of cooperating with a rail provided at the front of a display surface, such as in particular the surface of a tray on a shelf.

According to the invention, the fastening means consist of a jumper exhibiting:
an end interlocking means capable of cooperating with at least at one corresponding lateral end of the rail; and
a hinging means capable of allowing, in a first position of the jumper, the insertion of the latter in the rail and, in a second position, the internal locking of the jumper.

### BRIEF DESCRIPTION OF THE SEVERAL VIEWS OF THE DRAWINGS

The invention will be understood better when reading the following description, accompanied by the appended drawings which are integral part thereof.

FIG. 1 is a sectional view illustrating the placement of the jumper of a tag holder, according to an embodiment of the invention, in a C-shaped rail for instance.

FIG. 2 is a sectional view of the tag holder, as illustrated on FIG. 1, showing the jumper of the tag holder in an intermediate position where it cooperates with the lateral ends of the C-shaped rail.

FIG. 3 is a sectional view of the tag holder, as illustrated on FIG. 2, showing the jumper of the tag holder locked in a stable state where it cooperates with the C-shaped rail.

### DETAILED DESCRIPTION OF THE INVENTION

The present invention relates to a tag holder exhibiting supporting means 2 for the display of information, such as in particular a price tag, as well as a fastening means capable of cooperating with a rail 4, provided at the front of a display surface, such as the surface of a tray 13 on a shelf.

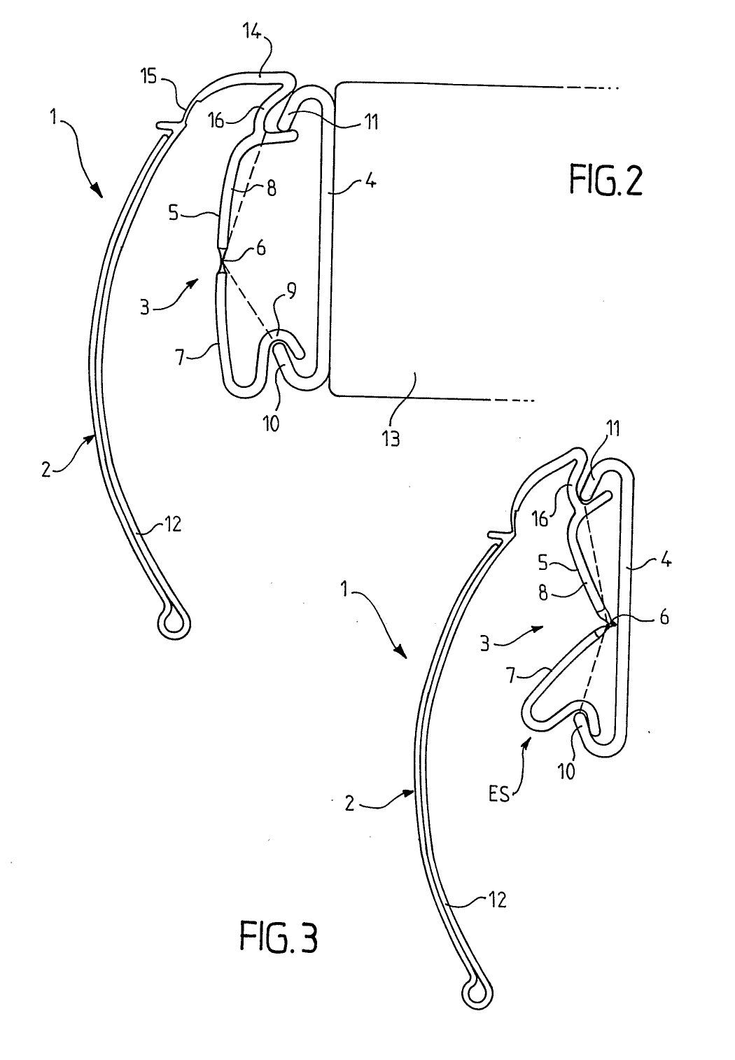

“Front of a display surface” means that a rail, in particular a C or E-shaped rail, is provided at the proximal end of the display surface, regardless whether on the horizontal, upper or lower surface of the display surface or provided on the front edge of a tray 13, as illustrated on FIG. 2.

According to the invention, the fastening means 3 consists of a jumper 5 exhibiting:
an end interlocking means 9, 16 capable of cooperating with at least at one corresponding lateral end 10, 11 of the rail; and
a hinging means 6 capable of allowing in a first position of the jumper the insertion of the latter in the rail 4 and in a second position the internal locking of the jumper 5. As illustrated on the Figures, the hinging means 6 are arranged longitudinally to the jumper 5.

More precisely, said jumper 5 exhibits a longitudinal pivot pin 6, so that it rests in the rail 4, by a pressure during which said jumper 5 deforms along its longitudinal pivot pin 6, to switch from an unstable compression state to a lower stable compression state, wherein the pivot pin 6 abuts against the bottom of the rail 4.

According to an embodiment, the end interlocking means 9, 16 of the jumper 5 form dummy hinges capable of cooperating with the bent edges 10, 11 of the rail 4.

Also, as illustrated on FIG. 2, the interlocking means 9, 16 are positioned at the bent edges 10, 11 of the C-shaped rail. In this position, the jumper is hardly, if at all, subjected to compression loads from the rail.

To attach the jumper inside the rail, a pressure is exerted substantially at the longitudinal pivot pin 6. The jumper will then be subjected to a compression load, the jumper being forced to deform elastically to switch to an unstable compression state at a hard spot. This state corresponds to a position of the jumper where the end interlocking means 9, 16, forming the dummy hinges as well the longitudinal pivot pin 6, are contained in a same plane.

Also, when the pivot pin 6 goes beyond this position, it is forced to extend in the rail so as to be finally blocked against the bottom of the latter, as illustrated on FIG. 3.

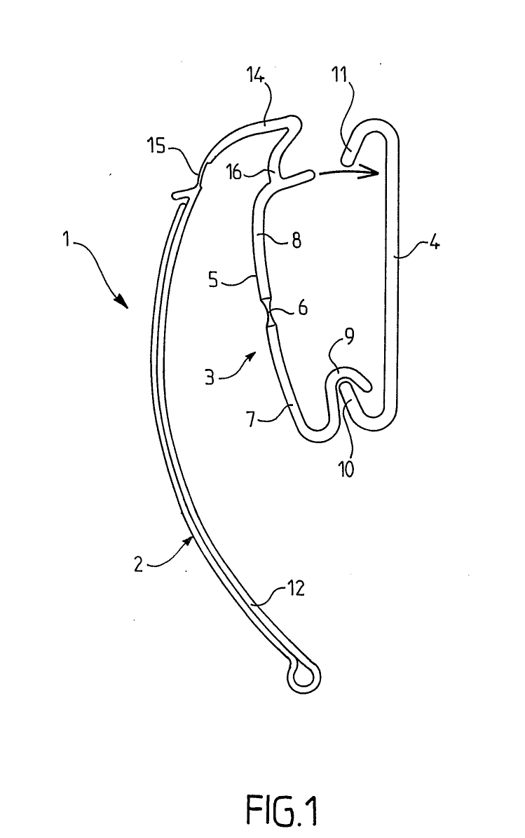

Advantageously, as illustrated on FIG. 1, when the jumper 5 is at rest, the end interlocking means 9, 16 are spaced apart by a distance enabling positioning of the jumper in the rail, without squeezing the latter.

In this position, as illustrated on FIG. 2 by the dotted line, the jumper may be hinged so as to press against the edges of the rail.

In another non-illustrated embodiment, in order to exert greater loads on said rail and hence improving the fastening, the jumper can be, at rest, of width slightly greater than the rated width of the C-shaped rail. Hence the jumper must be slightly squeezed to locate the interlocking means on the bent edges 10, 11 of the rail.

Advantageously, the pivot pin 6 is made of a so-called soft material, exhibiting a high friction coefficient. Also, when the latter is pressed against the bottom of the rail, it prevents the tag holder from slipping in translation along the rail.

According to an embodiment, the pivot pin 6 is provided by means of a reducing zone of flexible material. The jumper is formed of a material exhibiting resilient properties, in particular from at least one plastic material.

As illustrated in the Figures, the jumper 5 exhibits a first portion 7 as a hinged semi-E-shaped profile, and, at said hinging means 6, a second portion 8 has a Y-shaped profile.

The concave leg of the first portion 7 of the semi-E-shaped profile and the fork of the second portion 8 with the Y-shaped profile form said dummy hinges.

As illustrated on FIG. 2, the jumper 5 is capable of being fixed to the rail 4, said rail being designed for extending longitudinally along a tray 13 at a height corresponding substantially to the front edge of the latter.

The tag holder exhibits moreover a pocket 12 for the reception of a tag capable of protruding downwards, beneath said tray 13. The pocket 12 is connected to the jumper at a linking profile 14 exhibiting a flexible pivot pin 15 enabling the switchover of the pocket 12 upwards ahead of said tray 13. Such an arrangement enables advantageously that the tag holder 1 does not form an obstacle when a customer removes an item arranged just behind the pocket 12 of the tag holder.

The invention also relates to a method for the manufacture of a tag holder according to claim 1, the tag holder exhibiting supporting means 2 for the display of information, such as in particular a price tag, as well as fastening means 3 capable of cooperating with a rail 4, wherein said fastening means 3 consist of a jumper 5 capable of cooperating with the rail 4, said jumper exhibiting:
an end interlocking means 9, 16 capable of cooperating with at least at one corresponding end 10, 11 of the rail; and
a hinging means 6 capable of allowing, in a first position of the jumper, the insertion of the latter in the rail, and, in a second position, the internal locking of the jumper 5.

According to the process of the invention, the tag holder is extruded from at least a plastic material.

According to an embodiment, the tag holder is co-extruded from at least two plastic materials, said hinging means 6 at least being extruded from a first plastic material exhibiting characteristics considered as soft or flexible. The remainder of the tag holder is extruded from a second plastic material exhibiting characteristics considered as rigid, or semi-rigid.

The invention may, for instance, be made of a polymer, such as PVC by selecting a so-called flexible PVC for the pivot pin 6, and a so-called PVC for the remainder of the tag holder.

Obviously, other embodiments, understandable to the man of the art, could have been contemplated without departing from the framework of this application as defined by the claims below.

1. A tag holder comprising:
a supporting means having information on a display, said display being a price tag; and
a fastening means being cooperative with a rail provided on a front end of a display surface, said display surface being a tray of a shelf, said fastening means comprising:
an end interlocking means cooperating with at least at one corresponding lateral end of the rail; and
a hinging means having a jumper in a first position with said jumper inserted in the rail and in a second position with said jumper being internally locked.

2. A tag holder according to claim 1, wherein said jumper is comprised of a longitudinal pivot pin, the pivot pin resting on the rail by, said jumper being longitudinally deformed along said longitudinal pivot pin, said jumper being switched from an unstable compression state to a lower stable compression state, the lower stable compression state being set by the pivot pin abutted against a bottom of the rail.

3. A tag holder according to claim 2, wherein the pivot pin is comprised of a flexible material, exhibiting a friction coefficient.

4. A tag holder according to claim 2, wherein said jumper is comprised of at least one plastic material, the pivot pin being comprised of a reducing zone of flexible material.

5. A tag holder according to claim 1, wherein said jumper is comprised of a material exhibiting resilient properties.

6. A tag holder according to claim 1, wherein said end interlocking means form dummy hinges cooperative with bent edges of the rail.

7. A tag holder according to claim 6, wherein said jumper has a first portion with a hinged semi-s-shaped profile and a second portion with a Y-shaped profile at said hinging means, said first portion having a concave leg with a semi-E-shaped profile, said second portion having a fork of the Y-shaped profile, said concave leg and said fork forming said dummy hinges.

8. A tag holder according to claim 1, wherein said jumper fixedly attaches to the rail, the rail extending longitudinally along a tray at a height corresponding essentially to a front edge of the tray, said tag holder further comprising:
a pocket receiving a tag protruded downwards and beneath said tray.

9. A tag holder according to claim 8, wherein said pocket connects to said jumper at a linking profile with a flexible pivot pin, enabling switchover of said pocket upwards ahead of said tray.

10. A method for the manufacture of a tag holder according to claim 1, the method comprising the steps of:
forming a support for information on a display; and
forming a fastener cooperating with a rail, said fastener being comprised of a jumper being cooperative with the rail, said jumper being comprised of an end interlock cooperative with at least one corresponding lateral end of the rail and a hinge enabling insertion of the jumper in the rail in a first position and internal locking of the jumper in a second position, said support and fastener being extruded from a plastic material.

11. A method according to claim 10, wherein said plastic material is comprised of a first plastic material and a second plastic material, said jumper having a longitudinal pivot pin extruded from said first plastic material, said first material being flexible, remaining parts being extruded from said second plastic material exhibiting characteristics considered as rigid or semi-rigid.
